(19) United States
(12) Patent Application Publication
(10) Pub. No.: US 2023/0194945 A1
(43) Pub. Date: Jun. 22, 2023

(54) DISPLAY DEVICE

(71) Applicant: Japan Display Inc., Tokyo (JP)

(72) Inventors: Shimon ITAKURA, Tokyo (JP); Yasuhiko YAMAGISHI, Tokyo (JP); Tomohide OOHIRA, Tokyo (JP)

(73) Assignee: Japan Display Inc., Tokyo (JP)

(21) Appl. No.: 18/084,574

(22) Filed: Dec. 20, 2022

(30) Foreign Application Priority Data
Dec. 22, 2021 (JP) 2021-208477

(51) Int. Cl. G02F 1/137; G02F 1/1347

(52) U.S. Cl. CPC G02F 1/137; G02F 1/1347; G02F 1/133314

(57) ABSTRACT

According to one embodiment, a display device includes a liquid crystal display panel including a first effective area and a first non-display area, a dimming panel including a second effective area and a second non-display area, a plurality of first pixels provided in matrix in first and second directions intersecting each other in the first effective area, and a plurality of second pixels provided in matrix in the first direction and the second direction in the second effective area. Of the second pixels, the outermost pixel adjacent to the second non-display area overlaps the first non-display area.

### CROSS-REFERENCE TO RELATED APPLICATIONS

This application is based upon and claims the benefit of priority from Japanese Patent Application No. 2021-208477, filed Dec. 22, 2021, the entire contents of which are incorporated herein by reference.

### FIELD

Embodiments described herein relate generally to a display device.

### BACKGROUND

In recent years, a technology of using a display panel for light modulation in addition to a display panel for image display to improve the contrast of a display device has been developed.

### BRIEF DESCRIPTION OF THE DRAWINGS

FIG. 1 is an exploded perspective view schematically showing the configuration of a display device comprising two display panels.

FIG. 2 is a cross-sectional view showing a schematic example of the display device.

FIG. 3 is a diagram showing a schematic cross-sectional view of a display device according to a comparative example.

FIG. 4 is a diagram showing a schematic cross-sectional view of a display device according to a comparative example.

FIG. 5 is an external view of the display device viewed by eyes EB1.

FIG. 6 is an external view of the display device viewed by eyes EB2.

FIG. 7 is an external view of the display device viewed by eyes EB3.

FIG. 8 is a diagram showing a schematic cross-sectional view of the display device according to the present embodiment.

FIG. 9 is a diagram showing a schematic cross-sectional view of the display device according to the present embodiment.

FIG. 10 is a plan view of the display device according to the present embodiment.

FIG. 11 is a plan view showing the layout of pixels.

FIG. 12 is a cross-sectional view showing a configuration example of the display device according to the present embodiment.

FIG. 13 is a partial enlargement view of FIG. 12.

FIG. 14 is a plan view showing the layout of pixels.

FIG. 15 is a cross-sectional view showing a configuration example of the display device according to the present embodiment.

FIG. 16 is a plan view showing the layout of pixels in the configuration example.

### DETAILED DESCRIPTION

In general, according to one embodiment, a display device comprises: a liquid crystal display panel comprising a first effective area and a first non-display area; a dimming panel comprising a second effective area and a second non-display area; a plurality of first pixels provided in matrix in first and second directions intersecting each other in the first effective area; and a plurality of second pixels provided in matrix in the first direction and the second direction in the second effective area, wherein of the second pixels, the outermost pixel adjacent to the second non-display area overlaps the first non-display area.

According to another embodiment, a display device comprises: a liquid crystal display panel comprising a first effective area and a first non-display area; a dimming panel comprising a second effective area and a second non-display area; a plurality of first pixels provided in matrix in first and second directions intersecting each other in the first effective area; and a plurality of second pixels provided in matrix in the first direction and the second direction in the second effective area, wherein of the second pixels, the outermost pixel adjacent to the second non-display area has a width greater than a width of each of the other second pixels.

According to yet another embodiment, a display device comprises: a liquid crystal display panel comprising a first effective area and a first non-display area; a dimming panel comprising a second effective area and a second non-display area; a plurality of first pixels provided in matrix in first and second directions intersecting each other in the first effective area; and a plurality of second pixel units provided in matrix in the first direction and the second direction in the second effective area, wherein each of the second pixel units is provided such that one second pixel unit corresponds to three first pixels, and of the second pixel units, the outermost pixel unit adjacent to the second non-display area overlaps the first effective area and the first non-display area.

An embodiment provides a display device which prevents a display defect and has improved display quality.

Embodiments will be described hereinafter with reference to the accompanying drawings. The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, the same elements as those described in connection with preceding drawings are denoted by like reference numbers, and detailed description thereof is omitted unless necessary.

This specification explains the details of a display device according to an embodiment with reference to the accompanying drawings.

In the embodiment, a first direction X, a second direction Y and a third direction Z are orthogonal to each other. However, they may intersect each other at an angle other than 90 degrees. The third direction Z is defined as an upward direction or a direction toward an upper side. The opposite direction of the third direction Z is defined as a downward direction or a direction toward a lower side. The first direction X, the second direction Y and the third direction Z are also referred to as an X-direction, a Y-direction and a Z-direction, respectively.

When this specification uses the phrases “a second member above a first member” and “a second member on the lower side of a first member”, the second member may be in contact with the first member, or may be spaced apart from the first member. In the latter case, a third member may be interposed between the first member and the second member. When this specification uses the phases “a second member on a first member” and “a second member under a first member”, the second member is in contact with the first member.

It is assumed that a viewing position for viewing a display device is on the tip side of the arrow of the third direction Z. When the X-Y plane defined by the first direction X and the second direction Y is viewed at the viewing position, the appearance is referred to as a plan view. When the section of the display device in the X-Z plane defined by the first direction X and the third direction Z or in the Y-Z plane defined by the second direction Y and the third direction Z is viewed, the appearance is referred to as a cross-sectional view.

### Embodiment

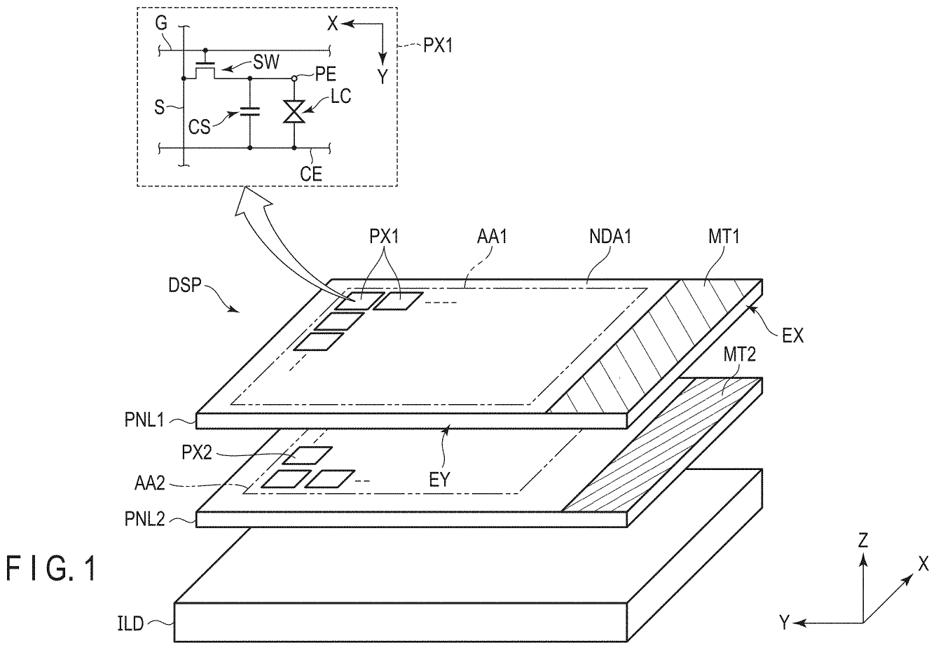

FIG. 1 is an exploded perspective view schematically showing the configuration of a display device comprising two display panels. FIG. 1 shows a three-dimensional space defined by a first direction X, a second direction Y perpendicular to the first direction X, and a third direction Z perpendicular to the first direction X and the second direction Y.

As shown in FIG. 1, the display device DSP comprises a liquid crystal display panel PNL1, a dimming panel PNL2 and an illumination device ILD. As shown in FIG. 1, by providing the dimming panel PNL2 between the liquid crystal display panel PNL1 and the illumination device ILD, the contrast of the image displayed in the liquid crystal display panel PNL1 can be improved.

The liquid crystal display panel PNL1 has, for example, a rectangular shape. In the example shown in the figure, the short side EX of the liquid crystal display panel PNL1 is parallel to the first direction X, and the long side EY of the liquid crystal display panel PNL1 is parallel to the second direction Y. The third direction Z is equivalent to the thickness direction of the liquid crystal display panel PNL1. The main surface of the liquid crystal display panel PNL1 is parallel to the X-Y plane defined by the first direction X and the second direction Y. The liquid crystal display panel PNL1 comprises an effective area (display area) AA1 and a non-display area NDA1 located outside the effective area AA1. The non-display area NDA1 comprises a terminal area MT1 in which a driver IC and a flexible wiring board are mounted. In FIG. 1, the terminal area MT1 is shown by hatch lines.

The effective area AA1 is an area for displaying an image, and comprises, for example, a plurality of pixels PX1 arrayed in matrix in the first direction X and the second direction Y. As shown in the enlarged view of FIG. 1, each pixel PX1 is provided in the area defined by scanning lines G and signal lines S and comprises a switching element SW, a pixel electrode PE, a common electrode CE, a liquid crystal layer LC, etc.

The switching element SW consists of, for example, a thin-film transistor (TFT), and is electrically connected to the scanning line G and the signal line S. Each scanning line G is electrically connected to the switching elements SW in the respective pixels PX1 arranged in the first direction X. Each signal line S is electrically connected to the switching elements SW in the respective pixels PX1 arranged in the second direction Y. The pixel electrode PE is electrically connected to the switching element SW. Each pixel electrode PE faces the common electrode CE. The liquid crystal layer LC is driven by an electric field generated between the pixel electrode PE and the common electrode CE. For example, capacitance CS is formed between an electrode having the same potential as the common electrode CE and an electrode having the same potential as the pixel electrode PE.

The terminal area MT1 extends along the short side EX of the liquid crystal display panel PNL1. A terminal portion is formed in the terminal area MT1. The liquid crystal display panel PNL1 is electrically connected to an external device such as a flexible wiring board via the terminal portion.

The dimming panel PNL2 basically comprises the same configuration as the liquid crystal display panel PNL1. The dimming panel PNL2 comprises a plurality of pixels PX2 provided in matrix in the first direction X and the second direction Y in an effective area (display area) AA2. The configuration of pixels PX2 is the same as pixels PX1. Thus, the detailed explanation thereof is omitted by using the above description. In the present embodiment, each pixel PX1 and each pixel PX2 comprise the same configuration and have the same size. More specifically, each pixel PX1 and each pixel PX2 comprise the same layer configuration. In addition, each pixel PX1 and each pixel PX2 have the same length in each of the first direction X and the second direction Y.

The dimming panel PNL2 comprises a non-display area NDA2 located outside the effective area AA2 in a manner similar to that of the liquid crystal display panel PNL1. The non-display area NDA2 comprises a terminal area MT2 in which a driver IC and a flexible wiring board are mounted. The non-display area NDA2 and the terminal area MT2 are the same as the non-display area NDA1 and the terminal area MT1, respectively.

The illumination device ILD is provided under the dimming panel PNL2. By controlling the light emitted from this illumination device ILD for each pixel PX, an image is displayed. The illumination device ILD of the present embodiment is a backlight.

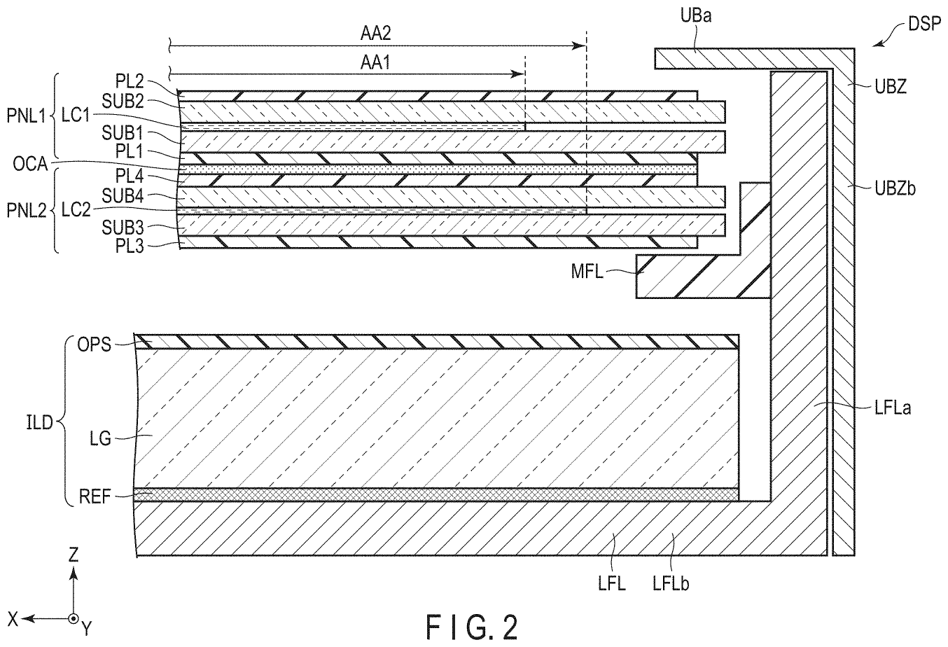

FIG. 2 is a cross-sectional view showing a schematic example of the display device. The display device DSP shown in FIG. 2 comprises the liquid crystal display panel PNL1, the dimming panel PNL2, an adhesive layer OCA, a mold frame MFL, the illumination device ILD, a lower frame LFL and an upper bezel UBZ.

The lower frame LFL comprises a bottom portion LFLb and a wall portion LFLa. The bottom portion LFLb has a rectangular shape extending in the X-Y plane. The wall portion LFLa protrudes from an end portion of the bottom portion LFLb in the third direction Z. The lower frame LFL is formed of, for example, a metal material.

The mold frame MFL is provided inside the space defined by the bottom portion LFLb and wall portion LFLa of the lower frame LFL. The wall portion LFLa of the mold frame MFL is in contact with the wall portion LFLa of the lower frame LFL. The mold frame MFL is formed of, for example, a resinous material.

The upper bezel UBZ comprises a flat portion UBZa and a wall portion UBZb. The flat portion UBZa has a shape extending in the X-Y plane. The wall portion UBZb protrudes from an end portion of the flat portion UBZa in the third direction Z. The upper bezel UBZ is formed of, for example, a metal material.

The liquid crystal display panel PNL1 comprises a first substrate SUB1, a second substrate SUB2, a first polarizer PL1 and a second polarizer PL2.

A liquid crystal layer LC1 is held between the first substrate SUB1 and the second substrate SUB2 and is sealed in by a sealant. The first polarizer PL1 is provided under the first substrate SUB1, and the second polarizer PL2 is provided on the second substrate SUB2. The polarization axis of the first polarizer PL1 and the polarization axis of the second polarizer PL2 are in a relationship of crossed-Nicol, in other words, 90 degrees.

The dimming panel PNL2 comprises a third substrate SUB3, a fourth substrate SUB4, a third polarizer PL3 and a fourth polarizer PL4.

A liquid crystal layer LC2 is held between the third substrate SUB3 and the fourth substrate SUB4 and is sealed in by a sealant. The third polarizer PL3 is provided under the third substrate SUB3, and the fourth polarizer PL4 is provided on the fourth substrate SUB4. The polarization axis of the third polarizer PL3 and the polarization axis of the fourth polarizer PL4 are in a relationship of crossed-Nicol, in other words, 90 degrees. The directions of the polarization axis of the first polarizer PL1 of the liquid crystal display panel PNL1 and the polarization axis of the fourth polarizer PL4 of the dimming panel PNL2 may be the same as each other.

The illumination device ILD comprises a reflective sheet REF, a light guide LG and an optical sheet OPS. The reflective sheet REF, the light guide LG and the optical sheet OPS are provided in the third direction Z in this order. Although not shown in the figure, a light source element is provided so as to face a side surface of the light guide LG.

The optical sheet OPS is, for example, a prism sheet or a diffusion sheet. Further, for example, as the optical sheet OPS, two prism sheets and a diffusion sheet may be provided.

The reflective sheet REF reflects the light emitted from the light guide LG to the lower side and causes the light to enter the light guide LG again.

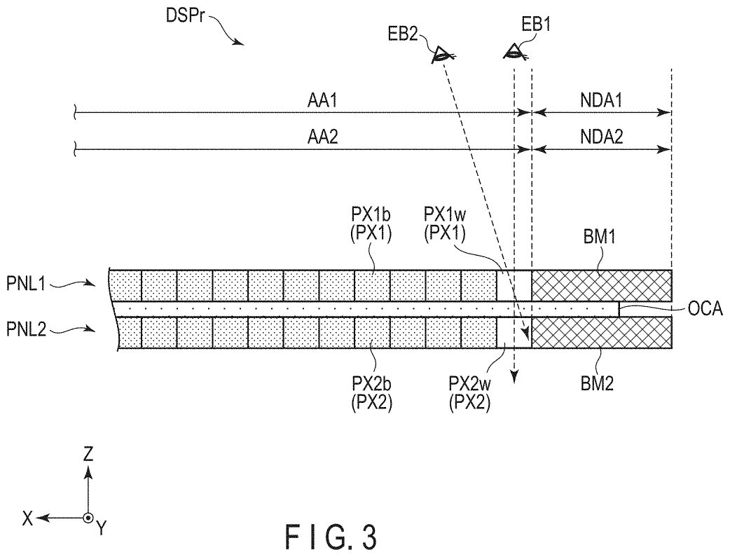

FIG. 3 is a diagram showing a schematic cross-sectional view of a display device according to a comparative example. In the display device DSPr shown in FIG. 3, it is assumed that each pixel PX1 of a liquid crystal display panel PNL1 and each pixel PX2 of a dimming panel PNL2 have the same width along the first direction X. In addition, although not shown in the figure, each pixel PX1 and each pixel PX2 have the same width in the second direction Y.

The pixel closest to a non-display area NDA1 is defined as pixel PX1w. Of pixels PX1, the pixels other than pixel PX1w are defined as pixels PX1b. The pixel closest to a non-display area NDA2 is defined as pixel PX2w. Of pixels PX2, the pixels other than pixel PX2w are defined as pixels PX2b. FIG. 3 shows a case where pixels PX1b and PX2b are caused to perform black display and pixels PX1w and PX2w are caused to perform white display in the display device DSPr.

In the non-display area NDA1, a light-shielding area BM1 is provided. In the non-display area NDA2, a light-shielding area BM2 is provided. In the light-shielding areas BM1 and BM2, for example, a light-shielding layer using a light-shielding material in which black pigment is dispersed in a resinous material or a metal material may be provided.

Pixels PX1w and PX2w overlap each other as seen in plan view. It is assumed that an observer views the display device DSPr in the opposite direction of the third direction Z from directly above pixels PX1w and PX2w. In this case, the eyes of the observer are defined as eyes EB1.

Further, it is assumed that an observer views the display device DSPr from pixel PX1w in a direction inclining with respect to the third direction Z. In this case, the eyes of the observer are defined as eyes EB2.

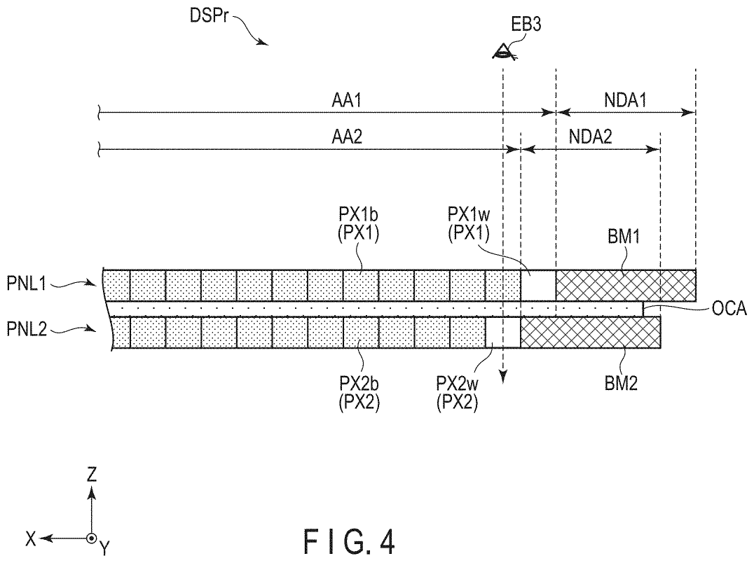

FIG. 4 is a diagram showing a schematic cross-sectional view of a display device according to a comparative example. In the display device DSPr shown in FIG. 4, the boundary between an effective area AA1 and a non-display area NDA1 is not coincident with the boundary between an effective area AA2 and a non-display area NDA2 as seen in plan view. In the display device DSPr shown in FIG. 4, the attachment between a liquid crystal display panel PNL1 and a dimming panel PNL2 is displaced.

In FIG. 4, for example, pixel PX1w overlaps a light-shielding area BM2 as seen in plan view, and pixel PX1b adjacent to pixel PX1w overlaps pixel PX2w as seen in plan view.

It is assumed that an observer views the display device DSPr in the opposite direction of the third direction Z from directly above pixel PX1w. In this case, the eyes of the observer are defined as eyes EB3.

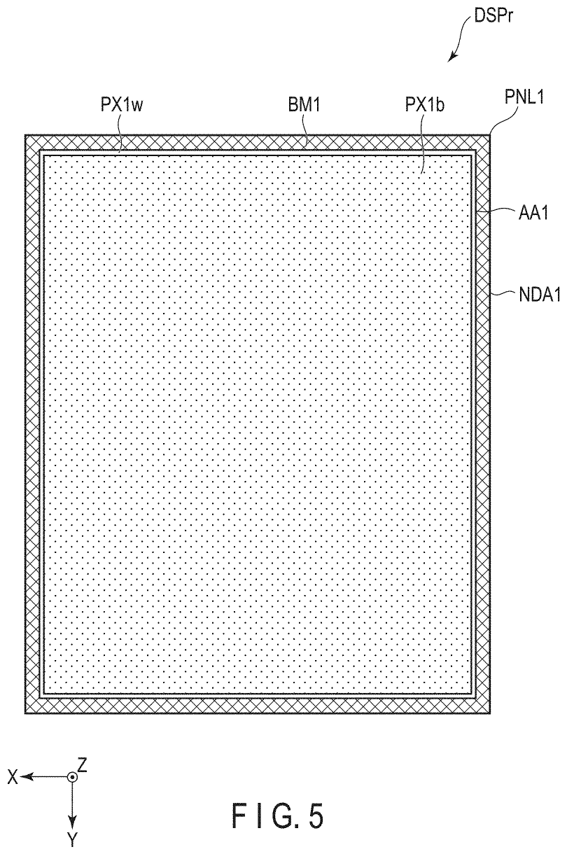

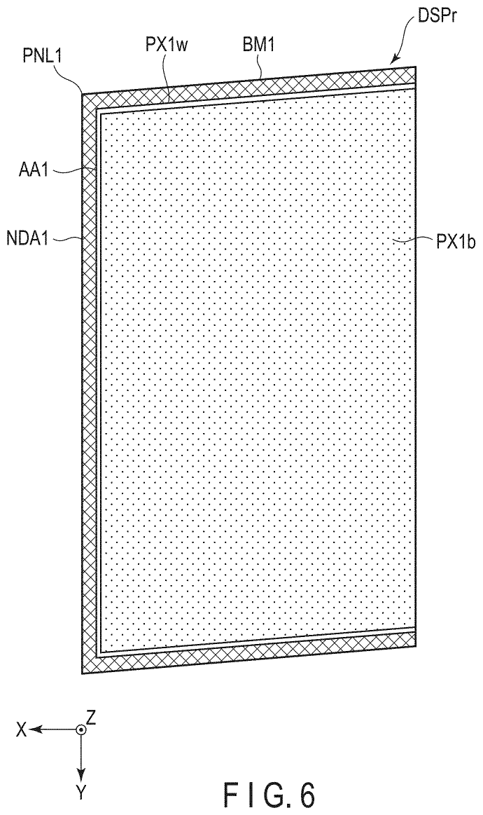

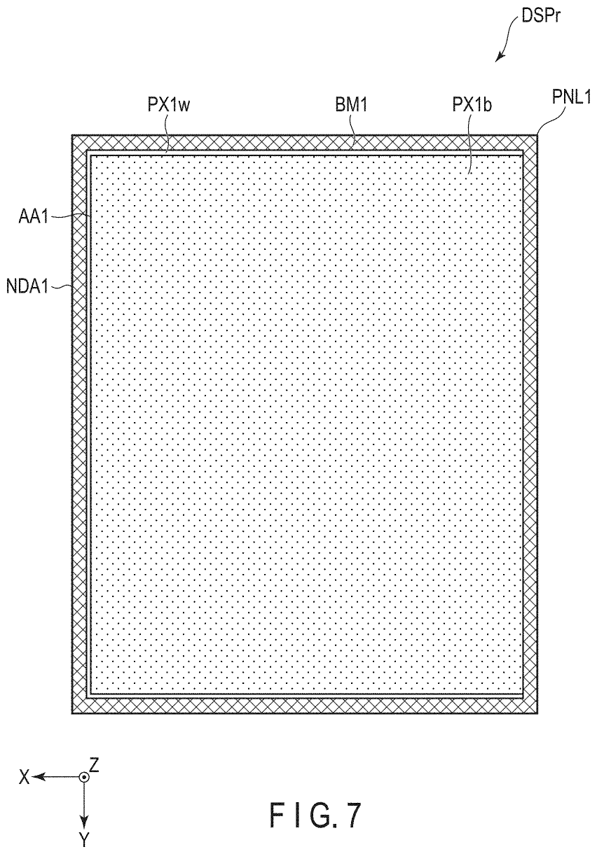

The display device DSPr viewed by eyes EB1, EB2 and EB3 are shown in FIG. 5 to FIG. 7. FIG. 5 is an external view of the display device viewed by eyes EB1. FIG. 6 is an external view of the display device viewed by eyes EB2. FIG. 7 is an external view of the display device viewed by eyes EB3.

As described above, the light-shielding area BM1 is provided in the non-display area NDA1. Thus, the color of the non-display area NDA1 is recognized as black by the observer. Of the effective area AA1, the color of the area occupied by pixels PX1b is recognized as black as pixels PX1b perform black display. Of the effective area AA1, the color of the area occupied by pixel PX1w is recognized as white. In other words, the area occupied by pixel PX1w which performs white display is provided between the non-display area NDA1 which performs black display and the area occupied by pixels PX1b.

As shown in FIG. 5, when the display device DSPr is viewed by eyes EB1, as pixels PX1w and PX2w overlap each other as seen in plan view, the area occupied by pixels PX1w and PX2w is viewed as a white frame.

As shown in FIG. 6, when the display device DSPr is viewed by eyes EB2, the light-shielding area BM2 which is adjacent to pixel PX2w and provided in the non-display area NDA2 is viewed through pixel PX1w. In this case, the color of part of the area occupied by pixel PX1w is recognized as black. In FIG. 6, the color of the column of pixels PX1w located on the right side of the figure is recognized as black.

As shown in FIG. 7, when the display device DSPr is viewed by eyes EB3, the light-shielding area BM2 of the non-display area NDA2 is viewed through pixel PX1w. In a manner similar to that of FIG. 6, the color of part of the area occupied by pixel PX1w is recognized as black. In FIG. 7, similarly, the color of the column of pixels PX1w located on the right side of the figure is recognized as black.

When the color of the area which should be originally recognized as white is recognized as black as shown in FIG. 6 and FIG. 7, in other words, when part of the effective area AA1 is defective, the display quality is degraded. In particular, as explained using eyes EB2, when the effective area AA1 is viewed obliquely with respect to the third direction Z, the display defect is noticeable.

In the present embodiment, pixel PX2 adjacent to the non-display area NDA2 is provided in the area overlapping the non-display area NDA1 in addition to the area overlapping the effective area AA1 as seen in plan view. In other words, the effective area AA2 expands to the outside of the effective area AA1. In this way, it is possible to prevent a display defect and improve the display quality.

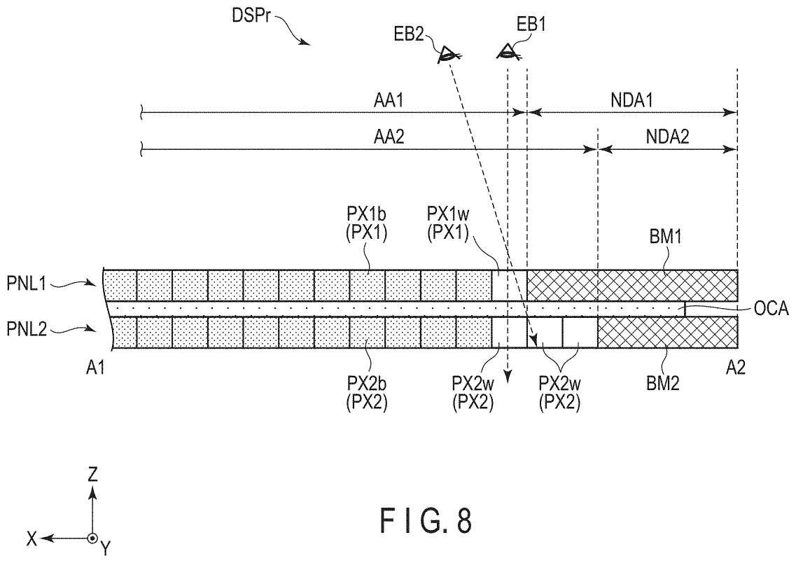

FIG. 8 is a diagram showing a schematic cross-sectional view of the display device according to the present embodiment. In the display device DSP shown in FIG. 8, the effective area AA1 of the liquid crystal display panel PNL1 overlaps the effective area AA2 of the dimming panel PNL2 as seen in plan view. The effective area AA2 overlaps the effective area AA1 and non-display area NDA1 of the liquid crystal display panel PNL1 as seen in plan view. The boundary between the effective area AA1 and the non-display area NDA1 is not coincident with the boundary between the effective area AA2 and non-display area NDA2 of the dimming panel PNL2 as seen in plan view.

In FIG. 8, three pixels PX2 adjacent to the boundary between the effective area AA2 and the non-display area NDA2 are defined as pixels PX2w. The same signal is input to pixels PX2w from the outside. One of the three pixels PX2w overlaps pixel PX1w as seen in plan view. In FIG. 8, pixel PX2w adjacent to pixel PX2b overlaps pixel PX1w.

In a manner similar to that of FIG. 3, it is assumed that an observer views the display device DSP in the opposite direction of the third direction Z from directly above pixel PX1w. In this case, the eyes of the observer are defined as eyes EB1.

Further, it is assumed that an observer views the display device DSP from pixel PX1w in a direction inclining with respect to the third direction Z. In this case, the eyes of the observer are defined as eyes EB2.

When the display device DSP is viewed by eyes EB1, in a manner similar to that of FIG. 5, as pixels PX1w and PX2w overlap each other as seen in plan view, the area occupied by pixel PX1w is viewed as a white frame.

When the display device DSP is viewed by eyes EB2, in a manner different from that of FIG. 3, pixel PX2w which does not overlap pixel PX1w is viewed through pixel PX1w. As pixel PX1w and pixel PX2w perform white display, in a manner similar to that of FIG. 5, the area occupied by pixel PX1w is viewed as a white frame. In other words, in a manner different from that of FIG. 6, the color of the area occupied by pixel PX1w is not recognized as black. In this way, even when the display device DSP shown in FIG. 8 is viewed obliquely with respect to the third direction Z, a display defect does not occur.

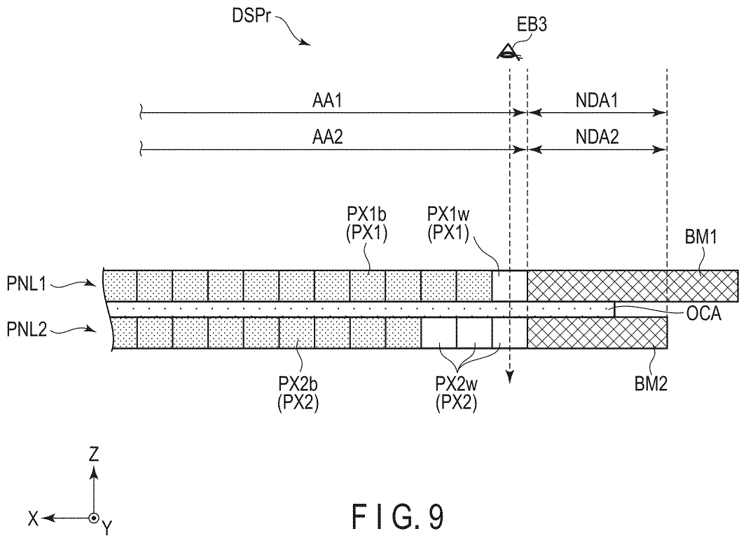

FIG. 9 is a diagram showing a schematic cross-sectional view of the display device according to the present embodiment. FIG. 9 shows a case where the attachment between the liquid crystal display panel PNL1 and the dimming panel PNL2 is displaced in the display device DSP shown in FIG. 8. In FIG. 9, pixel PX1w overlaps, of three pixels PX2w, pixel PX2w adjacent to the non-display area NDA2. The dimming panel PNL2 shown in FIG. 9 is displaced in the first direction X by two pixels PX2 compared to the dimming panel PNL2 shown in FIG. 8.

In a manner similar to that of FIG. 4, it is assumed that an observer views the display device DSP in the opposite direction of the third direction Z from directly above pixel PX1w. In this case, the eyes of the observer are defined as eyes EB3. As pixel PX1w overlaps pixel PX2w, in a manner similar to that of FIG. 5, the area occupied by pixel PX1w is viewed as a white frame. In other words, in a manner different from that of FIG. 7, the color of the area occupied by pixel PX1w is not recognized as black. In the display device DSP shown in FIG. 9, even if the displacement of attachment occurs, a display defect is not caused.

In FIG. 9, of three pixels PX2w, pixel PX2w adjacent to the non-display area NDA2 overlaps pixel PX1w. However, the layout is not limited to this example. Pixel PX1w may overlap the middle one of the three pixels PX2w. As long as pixel PX1w overlaps one of the three pixels PX2w, the white display area is not defective.

In this way, even if the attachment between the liquid crystal display panel PNL1 and the dimming panel PNL2 is displaced, it is possible to prevent a display defect and improve the display quality.

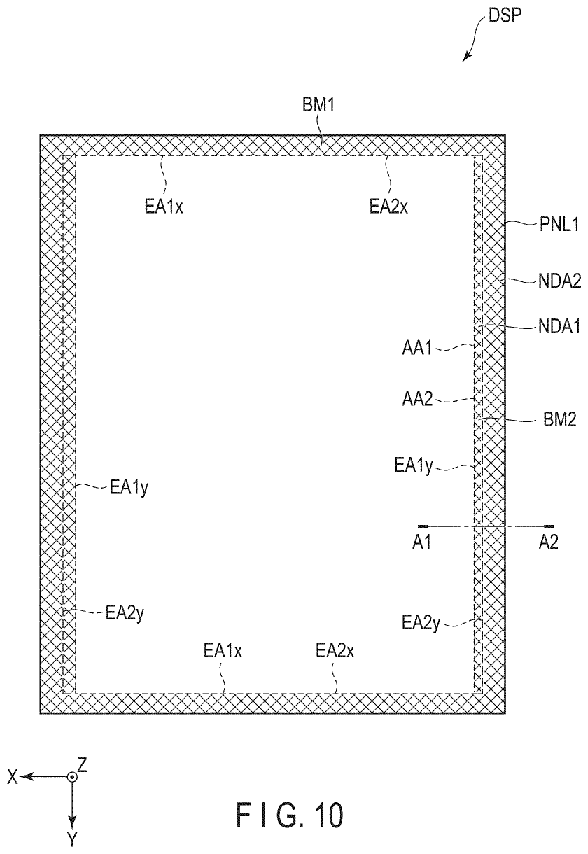

FIG. 10 is a plan view of the display device according to the present embodiment. The cross-sectional view of the display device DSP along the line Al-A2 in FIG. 10 is FIG. 8.d

In the display device DSP shown in FIG. 10, the length of the effective area AA1 along the first direction X is less than that of the effective area AA2 along the first direction X. The length of the effective area AA1 along the second direction Y is equal to that of the effective area AA2 along the second direction Y.

Of the sides of the effective area AA1, sides EA1y extending along the second direction Y are located on the internal side of, of the sides of the effective area AA2, sides EA2y extending along the second direction Y. Of the sides of the effective area AA1, sides EA1x extending along the first direction X are provided at the same positions as, of the sides of the effective area AA2, sides EA2x extending along the first direction X.

Pixels PX1 are provided in the effective area AA1. Pixels PX2 are provided in the effective area AA2. In the effective area AA2, the three pixels PX2w described above are provided between sides EA1y and EA2y. The same signal is input to the three pixels PX2w.

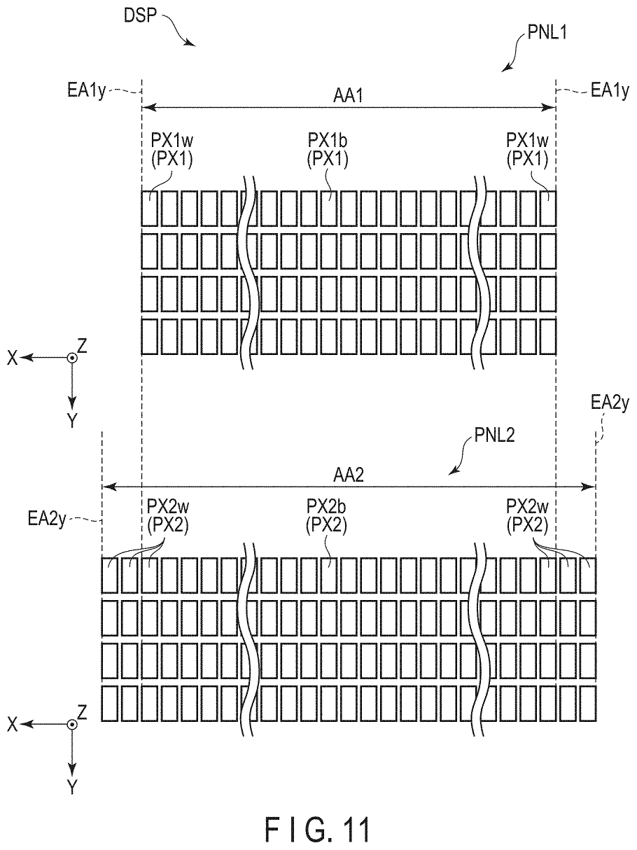

FIG. 11 is a plan view showing the layout of pixels. In FIG. 11, to explain the layout of pixels PX1 and PX2, pixels PX1 and PX2 which actually overlap each other are separately shown. As shown in FIG. 11, on each external side of the effective area AA1, two columns of pixels PX2 are provided. As explained above, each pixel PX1 has the same size as each pixel

PX2. Thus, the number of pixels PX2 is greater than the number of pixels PX1 by twice two columns, in other words, by four columns.

In the present embodiment, pixels PX2 of the dimming panel PNL2 are provided in the area outside the effective area AA1, in other words, the area overlapping the non-display area NDA1, in addition to the area overlapping the effective area AA1 as seen in plan view. In this configuration, when the display device DSP is viewed either in a direction parallel to the third direction Z or in a direction inclining with respect to the third direction Z, a display defect is not caused. In addition, even if the attachment between the liquid crystal display panel PNL1 and the dimming panel PNL2 is displaced, pixel PX2 overlaps pixel PX1. Thus, a display defect does not occur. As explained above, the display device DSP of the present embodiment can prevent a display defect and improve the display quality.

### CONFIGURATION EXAMPLE 1

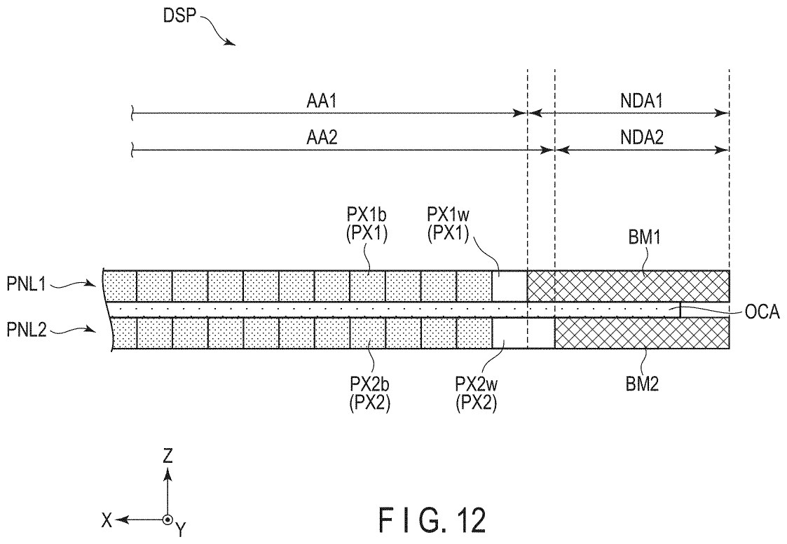

FIG. 12 is a cross-sectional view showing another configuration example of the display device according to the present embodiment. The configuration example shown in FIG. 12 is different from the configuration example shown in FIG. 8 in respect that, of pixels PX2 of the dimming panel PNL2, the width of pixel PX2 adjacent to the non-display area NDA2 is greater than that of the other pixels PX2.

Of pixels PX2 of the dimming panel PNL2, the length (width) of pixel PX2w adjacent to the non-display area NDA2 along the first direction X is greater than that of the other pixels PX2b provided in the effective area AA2. It is assumed that each pixel PX1 has the same width as each pixel PX2b. When the lengths (widths) of pixels PX1 and PX2b and pixel PX2w along the first direction X are defined as widths w1 and w2, respectively, width w2 is greater than width w1 (w2>w1). The lengths of pixels PX1, PX2b and PX2w along the second direction Y are equal to each other.

Here, it is assumed that an observer views the display device DSP in a direction inclining with respect to the third direction Z. For example, the condition which does not cause a display defect even when the display device DSP is viewed in a direction inclining at 45 degrees with respect to the third direction Z is assumed to be the minimum value of width w2.

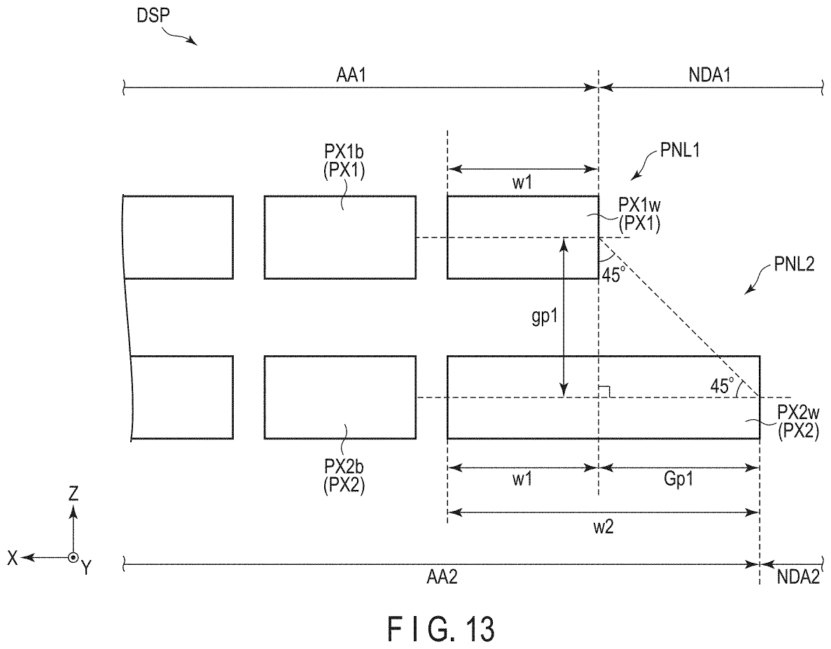

FIG. 13 is a partial enlargement view of FIG. 12. The interval (length) of pixels PX1 and PX2 along the third direction Z is defined as gp1. In the above case, to prevent a display defect, width w2 of pixel PX2w should be greater than width w1 of each pixel PX2b by length gp1. In other words, width w2 should be the sum of width w1 and length gp1 (W2=w1+gp1).

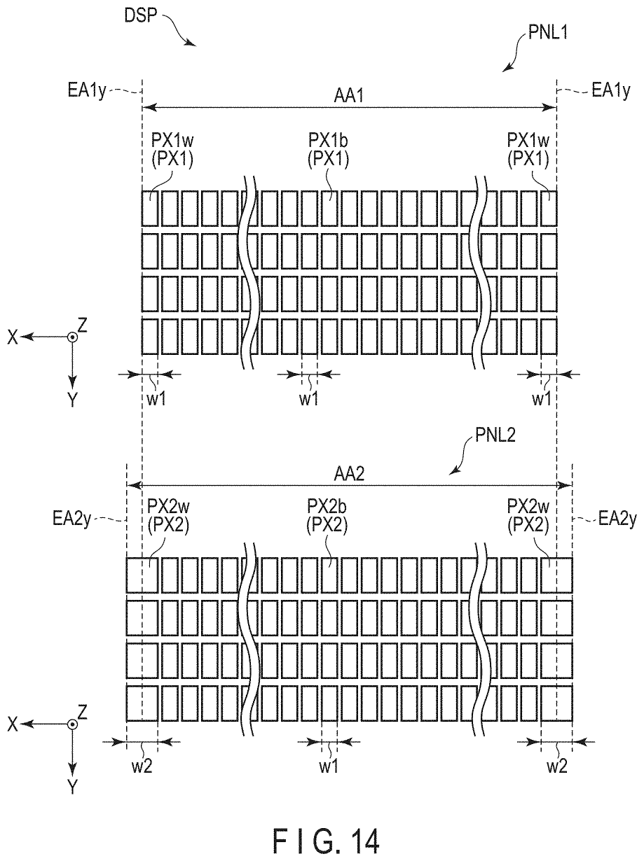

FIG. 14 is a plan view showing the layout of pixels. In FIG. 14, in a manner similar to that of FIG. 11, to explain the layout of pixels PX1 and PX2, pixels PX1 and PX2 which actually overlap each other are separately shown. As shown in FIG. 14, the columns of pixels PX2w having width w2 protrude to the outside of the effective area AA1.

In a manner different from that of FIG. 11, in FIG. 14, the number of pixels PX1 is equal to the number of pixels PX2. In this configuration example, effects similar to those of the embodiment are obtained by increasing the width of pixels PX2w.

### CONFIGURATION EXAMPLE 2

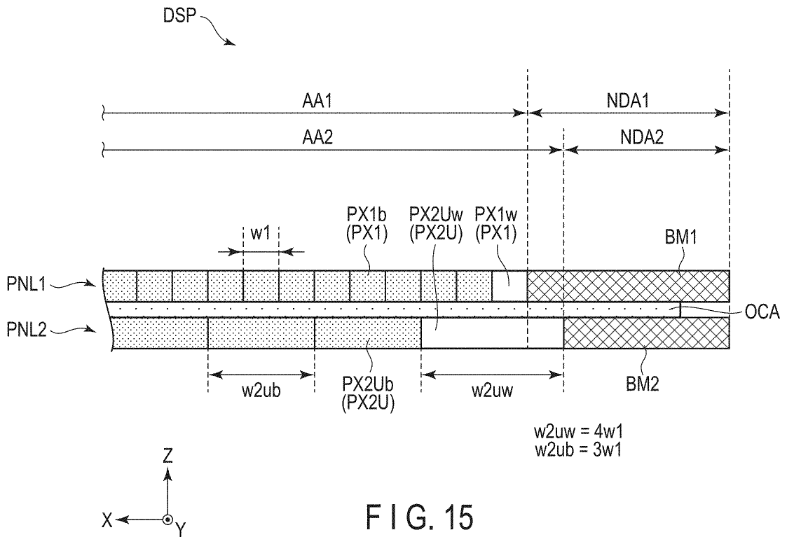

FIG. 15 is a cross-sectional view showing another configuration example of the display device according to the present embodiment. The configuration example shown in FIG. 15 is different from the configuration example shown in FIG. 8 in respect that a pixel unit PX2U is provided in the dimming panel PNL2 so as to correspond to a plurality of pixels PX1 of the liquid crystal display panel PNL1.

In the display device DSP shown in FIG. 15, the dimming panel PNL2 comprises the pixel units PX2U. A pixel unit PX2U is provided so as to correspond to three pixels PX1 of the liquid crystal display panel PNL1. The dimming panel PNL2 should at least transmit light and cause it to proceed to the liquid crystal display panel PNL1. Thus, the dimming panel PNL2 does not require a high definition compared to the liquid crystal display panel PNL1. For this reason, in this configuration example, the definition of the dimming panel PNL2 is a third (⅓) of that of the liquid crystal display panel PNL1.

Pixel unit PX2Uw adjacent to the non-display area NDA2 overlaps pixel PX1w and the non-display area NDA1. The width of pixel unit PX2Uw is greater than that of the other pixel units PX2Ub by one pixel PX1.

In FIG. 15, the lengths (widths) of pixel PX1, pixel unit PX2Ub and pixel unit PX2Uw along the first direction X are defined as widths w1, w2ub and w2uw, respectively. Width w2uw is four times width w1 (w2uw=4w1). Width w2ub is three times width w1 (w2ub=3w1).

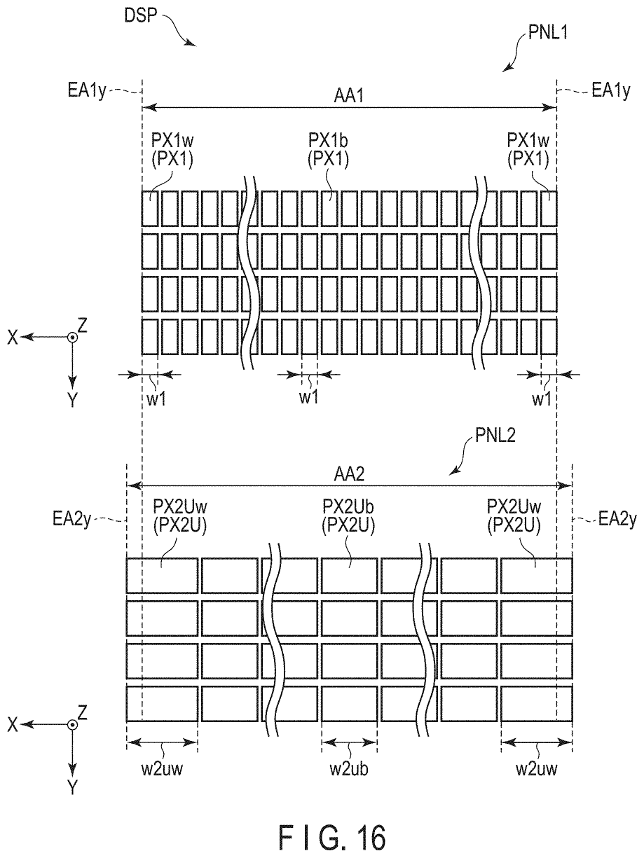

FIG. 16 is a plan view showing the layout of pixels in this configuration example. In FIG. 16, in a manner similar to that of FIG. 11, to explain the layout of pixels PX1 and pixel units PX2U, pixels PX1 and pixel units PX2U which actually overlap each other are separately shown. As shown in FIG. 16, the columns of pixel units PX2Uw having width w2uw protrude to the outside of the effective area AA1.

Effects similar to those of the embodiment are obtained from this configuration example.

In this disclosure, pixels PX1 and PX2 are also called first and second pixels, respectively. Pixel PX2w provided so as to be adjacent to the non-display area NDA2 is also called an outermost pixel.

In this disclosure, each pixel unit PX2U shown in FIG. 15 and FIG. 16 is also called a second pixel unit. Pixel unit PX2Uw adjacent to the non-display area NDA2 is also called an outermost pixel unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a liquid crystal display panel comprising a first effective area and a first non-display area;
a dimming panel comprising a second effective area and a second non-display area;
a plurality of first pixels provided in matrix in first and second directions intersecting each other in the first effective area; and
a plurality of second pixels provided in matrix in the first direction and the second direction in the second effective area, wherein
of the second pixels, the outermost pixel adjacent to the second non-display area overlaps the first non-display area.

2. The display device according to claim 1, wherein
the side extending along the second direction among sides of the first effective area is provided on an internal side of the side extending along the second direction among sides of the second effective area, and
the side extending along the first direction among the sides of the first effective area is provided at the same position as the side extending along the first direction among the sides of the second effective area.

3. The display device according to claim 1, wherein
each of the first pixels and each of the second pixels have the same length along each of the first direction and the second direction.

4. The display device according to claim 1, wherein
the number of second pixels is greater than the number of first pixels.

5. A display device comprising:
a liquid crystal display panel comprising a first effective area and a first non-display area;
a dimming panel comprising a second effective area and a second non-display area;
a plurality of first pixels provided in matrix in first and second directions intersecting each other in the first effective area; and
a plurality of second pixels provided in matrix in the first direction and the second direction in the second effective area, wherein
of the second pixels, the outermost pixel adjacent to the second non-display area has a width greater than a width of each of the other second pixels.

6. The display device according to claim 5, wherein
a first length of each of the second pixels other than the outermost pixel along the first direction is equal to a length of each of the first pixels along the first direction,
a direction intersecting with the first direction and the second direction is a third direction,
an interval of the first pixels and the second pixels in the third direction is a second length, and
a length of the outermost pixel along the first direction is a sum of the first length and the second length.

7. The display device according to claim 5, wherein
the side extending along the second direction among sides of the first effective area is provided on an internal side of the side extending along the second direction among sides of the second effective area, and
the side extending along the first direction among the sides of the first effective area is provided at the same position as the side extending along the first direction among the sides of the second effective area.

8. The display device according to claim 5, wherein
each of the first pixels and each of the second pixels other than the outermost pixel have the same length along each of the first direction and the second direction.

9. The display device according to claim 5, wherein
the number of first pixels is equal to the number of second pixels.

10. A display device comprising:
a liquid crystal display panel comprising a first effective area and a first non-display area;
a dimming panel comprising a second effective area and a second non-display area;
a plurality of first pixels provided in matrix in first and second directions intersecting each other in the first effective area; and
a plurality of second pixel units provided in matrix in the first direction and the second direction in the second effective area, wherein
each of the second pixel units is provided such that one second pixel unit corresponds to three first pixels, and
of the second pixel units, the outermost pixel unit adjacent to the second non-display area overlaps the first effective area and the first non-display area.

11. The display device according to claim 10, wherein
the side extending along the second direction among sides of the first effective area is provided on an internal side of the side extending along the second direction among sides of the second effective area, and
the side extending along the first direction among the sides of the first effective area is provided at the same position as the side extending along the first direction among the sides of the second effective area.
